(19) United States
(12) Patent Application Publication
(10) Pub. No.: US 2009/0006465 A1
(43) Pub. Date: Jan. 1, 2009

(54) Method and System For Matching Pre-Indexed Product Profiles to Consumers

(76) Inventor: Steven John Sue, Las Vegas, NV (US)

Correspondence Address: Deborah Neville, PO Box 61063, Palo Alto, CA, 94306, US

(21) Appl. No.: 12/087,499

(22) PCT Filed: Sep. 7, 2006
(86) PCT No.: PCT/US2006/034749

§ 371 Date: Jul. 8, 2008

(51) Int. Cl. G06F 17/30

(52) U.S. Cl. 707/103 R; 707/E17.055

(57) ABSTRACT

The invention provides a method and system for dynamically tailoring selection of products displayed to potential buyers based on a profile accounting for the buyer's personal interests, including future interests or goals. From a User interface connected to a communication network, products or other offerings are presented as selections that are relevant to User. Until a User completes a User Aspiration Profile (306), the first User action (e.g. a mouse click on or other single action to select a product or category of products depicted) causes the client to request the server to provide product data on products with User Aspiration Profile Ratings (308) similar to the rating of the first-clicked item. The User may also provide profile data, stating both current state and desired state personality characteristics. Such personality indexing corresponds to product indexing, such that the products or offerings presented to User bear a relevancy or match to his or he “User Aspiration Profile.”

### RELATED APPLICATIONS

Not applicable.

### GOVERNMENT FUNDING

Not applicable.

### BACKGROUND

The promise of a customized Internet experience and resulting World Wide Web-enabled commerce has not been realized. Overwhelmingly, efforts to “customize” to a user rely on language-based descriptors to define present state of User. Even so-called “personality-based” interfaces (see U.S. Pat. No. 5,890,152 issued to Rapaport et al.) rely on a key word based search engine that weights word relationships to deliver better search results. Despite use of the word “personality”, such methods are not tracking any specific metrics on generally accepted aspects of personality, such as, for example, thought functions. Rather, such methods simply determine a User's linguistic preferences to make suitable Internet word-based article searches more relevant to a user's linguistic ability. For example, a user searching for “butterflies” is subjected to some and word-use association evaluator in order to retrieve, as may be appropriate, a youth-oriented article to a child or a scientific article to a PhD candidate. In order to accomplish this, input data mis-characterized as “personality” data is collected, when in fact such input data is used to mere determine the user's language type and degree of language-based sophistication.

Moreover, word search engines match users to one time frame of interest (i.e. the present). So-called “on-line personal advertisements” and social networking oriented sites purporting to “match” people such as, for example, Match.com or eHarmony.com, use data (e.g., height, weight, eye color, etc.) as descriptors of the desired “match” and likewise use the seeker's own current state data (e.g., height, weight, income, education level, eye color, smoker, non-smoker, pet-owner, et cetera).

So too, current retailing, including e commerce websites such as Amazon.com, employ data of past buying behavior to promote or advertise. Moreover, retailing approaches particularly, via the Internet, are statically unresponsive to the consumer's “personality.” A single event, for example, of buying a “gift book” (say, for example, purchase of a gift on the topic of child rearing or skeet shooting for a friend or relation) oft times results in a periodic un-wanted deluge of commercial enticements to buy merchandise related to a past purchase yet utterly outside the range of interest of the buyer of record.

Such a waste of consumer attention is ever more costly in a climate of “information overload.” More than ever it behooves commercial enterprises to use every consumer contact to it fullest potential, and to assist consumers in gaining exposure to desired products or information. Further, as cycles and trends shorten, and global competition stiffens, retailers cannot afford to be unresponsive to indications of change in consumer preferences and behavior.

Consumers, too, use web-enabled devices to keep abreast of rapid changes and time sensitive data (e.g., changes in airline flights, traffic conditions, financial market conditions, ticket availability for a sporting or music event). However, on-line shopping, by and large, forces consumers to wade down through layers of offerings rather than quickly and accurately providing product information of demonstrable interest to the shopper. This is true even when a record of past purchases has been stored, if for the only reason that the past is again being used as a predictor of the future, rather than true customization accounting for a shoppers personality and goals.

What is needed is a method to match product or commercial offering or information tailored to the consumer or user, particularly via communication networks, and via the Internet and World Wide Web. What is further needed is a method and system to match products to a particular consumer based on consumer goals or aspirations. Further, what is needed is a method for defining and re-fining a consumer's personality to better match products or other offering. Further needed is a method of indexing products to correspond to user personality and to discriminate in the presentation of products to consumers on the basis of personality and aspirations. Further needed is a method of profiling Users and offerings, that is to say, a profiling methodology, including profiling metrics that applies ubiquitously, crossing the bounds of product categories.

### BRIEF SUMMARY OF THE INVENTION

The invention taught herein provides satisfaction of at least all of the above-recited needs.

The invention provides a system and method to characterize and quantify a User's “aspirations,” desired state (goals) and to tailor data presentation of products or other offerings consistent with the User's particular “User Aspiration Profile” (also referred to herein as UAP).

In the preferred embodiment, a User is presented products or other offerings based on a correlation (a “match”) of the products to the User Aspiration Profile and Offering Aspiration Profile Rating.

As described herein, the User Aspiration Profile is numerically-based Profile of a User's desired state derived in whole or in part from User response to stimulus calculated to correlate to User personality. The stimuli presented are designed to include not only measure physical attributes, but also to measure aspect including cognitive thought habits or emotional aspects (creative skills) that a user aspires to develop or express.

The invention provides a method for using elicited User data so as to quantify User personality into a pre-designed profiling index. By means of the profiling index, the User can be preferentially exposed to data (e.g. products or other offerings) where such data or products are or have been rated on a compatible or complementary indexing scheme, and thus are “matched” to the User's personality.

The client system presents the User with stimulus via the User Interface. In response to an indication of an action (e.g., a single action such as clicking a mouse button) that User is identified with a UAP. In response to the indicated action being performed, the client system sends the server system the UAP identifier and a request to present additional product information. The server system uses the UAP identifier to match the request with additional product information matching the UAP profile and then, through the client, provides additional product information to the User through a User interface. The server selects from among products that have been pre-indexed using a product rating system, and the product rating system is complementary to the User Profile system.

The server system stores the UAP. The server system also stores any additional information association with the User. When requested by a client system, the server system combines the additional stored information associated with the UAP.

The invention in the preferred embodiment provides a method of creating and refining one or more User Aspiration Profiles. During a User session, whether or not the User actively creates a User Profile, any stimulus selected by the User is determined to correspond to some User's Aspiration Profile based on a dynamically assigned or pre-assigned “Aspiration Profile Rating.”

In the case where a User merely clicks on or otherwise selects a single product category or depicted product, an assigned “proxy” User Aspiration Profile (derived from the User Aspiration Profile Rating of the selected product) is used, and objects that have similar User Aspiration Profile Ratings are selected for presentation, via a display or otherwise, to the User.

In the event the User creates a User Aspiration Profile, the server responds to requests accordingly. The User may create a custom profile, elect a short-cut profile, or assume another proxy profile, such as a “celebrity” profile (e.g., the profile of a sports figure or media personality).

In one embodiment, algorithms are employed to create User Aspiration Profile from a single action (e.g., mouse click on a product picture) or from an action indicating User response to profile creation stimuli (e.g., words, sounds, pattern, symbols). User Aspiration Profiles, may, for example, comprise recordation of User response with respect to a present state description, a future state (aspiration) description, and some comparison between the present and future state. From such User responses, a personal UAP is created. Different UAPs may be created for different domains (physical, emotional, social, intellectual) by varying the stimuli.

The UAP is further compared with profiles corresponding to personality “Archetype”—e.g. pre-characterized personality “types.” The profiling index of the invention provides a method of profiling using a set of profiling metrics, where such profiling metrics may be applied ubiquitously, crossing the bounds of product categories.

The User may re-create or refine his or her UAP through multiple profile creations on the same or different domains, and averaging any combination of the profiles. Other profile refinement approaches may be employed, including, but not limited to averaging multiple User input session, averaging User input with on-line behavior history, averaging User input and User-solicited input (e.g., spouse; physician; design consultant).

In one embodiment, the User Aspiration Profile addresses product categories according to a value basis such as self-improvement (e.g., who I am as a benchmark of the present, my goals and how I can get to my goals in the future) and enhancing one's identity or brand image (e.g., how I want to be portrayed; my image).

The invention provides for periodic automatic presentation of pre-indexed products that match the User Profile to portable devices capable of connecting to a network. The client may, as a result of code received from the server, for example, communicate requests at a pre-determined frequency without additional User action, and may thereby provide to User additional information. Such additional information may be provided to User on any device capable of connecting to a communication network, including, but not limited to mobile phone, Personal Digital Assistant (PDA), palmtop, and the like.

Profile creation for products or other offerings may also be performed with a single action, and such product profile stored in the appropriate database associated with the server. The invention provides profile adjustments based on actual User data, thereby providing empirically based profile indexing and ranking fine-tuning.

The invention provides for the compilation and analysis of aggregations of collected and stored User profile data as well as customizable reports. Further, the invention provides for automated and dynamic cross selling between related and un-related product categories.

### BRIEF DESCRIPTION OF THE DRAWINGS

FIG. 1A is a schematic of an embodiment of the inventive method, depicting process of creating a User Aspiration profile from a single-action response to stimulus and retrieving profile complementary data.

FIG. 1B depicts proxy User Aspiration profile averaging according to one embodiment of the invention.

FIG. 2 depicts an example of creation of User Aspiration Profile according to an embodiment of the invention.

FIG. 3 represents the flow of single action profile matching according to the present invention.

FIG. 4 is a block diagram illustrating an embodiment of the invention.

FIG. 5 illustrates “product push” from the search engine to the User.

FIG. 6A illustrates product profile creation, including single-action profile creation.

FIG. 6B is an example of custom product profile creation.

FIG. 6C is an example of single-action product profile creation.

FIG. 7 illustrates profile learning system according to the invention.

### DETAILED DESCRIPTION OF THE PREFERRED EMBODIMENT

Many of the practical aspects of the invention do not require drawings to be understood; the figures presented are illustrative only, and are not intended to limit the invention. The word “product” should be understood to include any offering, including but not limited to services and information as well as tangibles.

The invention provides a method and system for matching product profiles to consumer profiles in a client/server environment. The invention surpasses mere personalized consumer-type search engine approaches, and provides retailers with a tool to profile and pre-index products (or other offerings) with a single-action product profile indexing. Users are provided a “smart interface” which pre-filters product offerings and “learns” as a result of each User action; the server stores the User action information, and uses the User behavior to better match and present product offerings. User information is garnered from actions of User (e.g. what User selects from amongst stimulus), User data entry (e.g., response to stimulus calculated to measure personal “aspiration”), and user behavior (e.g. time spent on product information pages).

Moreover, the system also provides feedback to retailers, enabling product profile indexing information to be adjusted as a result of stored User information. Such aggregation of User profile data is a powerful tool providing retailers with a method to improve communication with User by tailoring product offerings to User activity, a method to study market conditions, a method to re-engineer existing or to engineer new offerings through a data feedback loop.

Further the system may “push” products to any User designated device (e.g. computer, kiosk, PDA, smart phone, etc.), responding to initial User activity at times and through communication devices personalized to User. The invention also works in manual printed versions, including but not limited to hand-written Aspiration Profiling inputs, manual index scoring and association to various in-store devices such as hangtags, labels and signage devices.

Beginning with the first single User action, the client sends User profile information to the server, and the server responds with product data tailored to “match” or correspond to the transmitted User profile. User action, as used herein, is intended to include and is not limited to clicking a mouse-button when cursor is positioned over a pre-defined area of display; touching the display screen over a pre-defined area of display; generating a sound; depressing a key on a key pad; pointing using a pointing device; selecting using a selecting device.

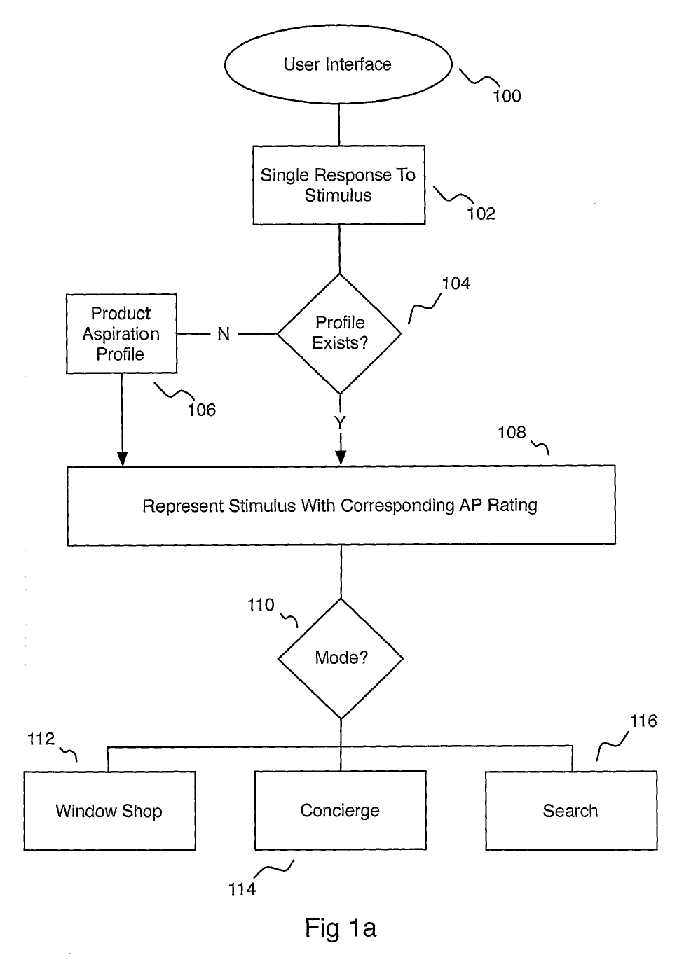

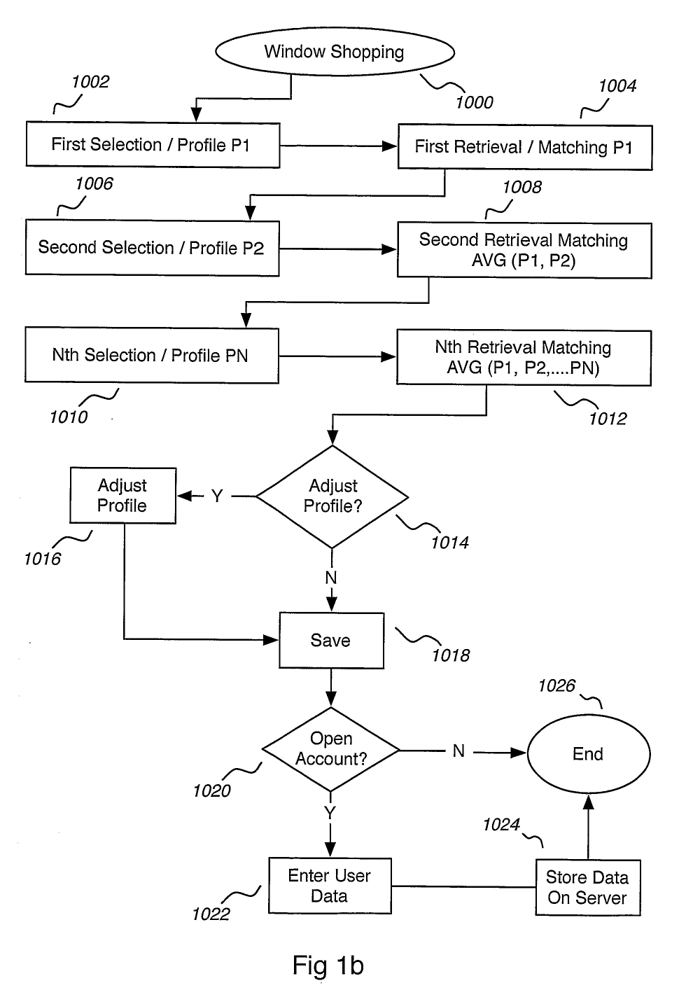

FIG. 1A illustrates the method of creating a User Aspiration Profile from a single-action response to stimulus and retrieving profile complementary data. At the User interface 100 a User is presented some stimulus (e.g., choices for selection). The User indicates “choice” in a single response to stimulus 102. The client transmits the User action as a request to the server.

If a profile of the User exists, the server responds by re-presenting additional stimulus corresponding to the User Profile, and such stimulus as selected by the server for presentation to User have an associated “Aspiration Profile Rating” (AP Rating) 108. If no User profile exists, the server assigns the profile most closely associated with the stored User Aspiration Profile Rating UAP Rating) associated with the selected stimulus. The User may select from a variety of modes 110, including “window shop” 112, “concierge” 114 or “search” 116. Absent a User selection, “window shop” 112 is the default mode.

The invention provides a method and system for User profile learning for providing ever better matches of products to the User, beginning with the first User action. In the case where a User has not created a UAP (User Aspiration Profile), the invention provides a method for assigning and refining a UAP based on User activity during one or more sessions mediated by a client. Beginning with “window shopping” 1000 (the default starting mode at the User interface) a first UAP, at the first User selection a proxy UAP is assigned (P1) 1002. As discussed above, the UAP assigned is the UAP Rating of the product. The server responds to the client transmission of P1 with a first retrieval matching P1 1004. The first retrieval comprises a communicable response (in the form of a web page, page element, or other communication medium perceivable by the User) of one or more products assigned UAP Ratings matching in whole or in part the assigned profile P1.

In response to a second User selection, a second profile P2 is transmitted by the client to the server. The server responds with a second retrieval matching the average of P1 and P2 1008. FIG. 1B depicts proxy User Aspiration profile averaging according to one embodiment of the invention. The process of selection, profile averaging and retrieval repeat, so at the Nth selection, a profile of PN is transmitted, and the server responds with the Nth retrieval matching the average of (P1, P2 . . . PN) 1012.

At any point, a User may select Adjust profile 1014 and adjust his or her profile 1016. Profiles are stored in the server (Save 1018) if the User does not delete. The server sends the client a prompt for the User to open account 1020, and then presents User requests for additional User data (e.g., name, age, gender, address) 1022. All data is sent by the client to the server and stored 1024.

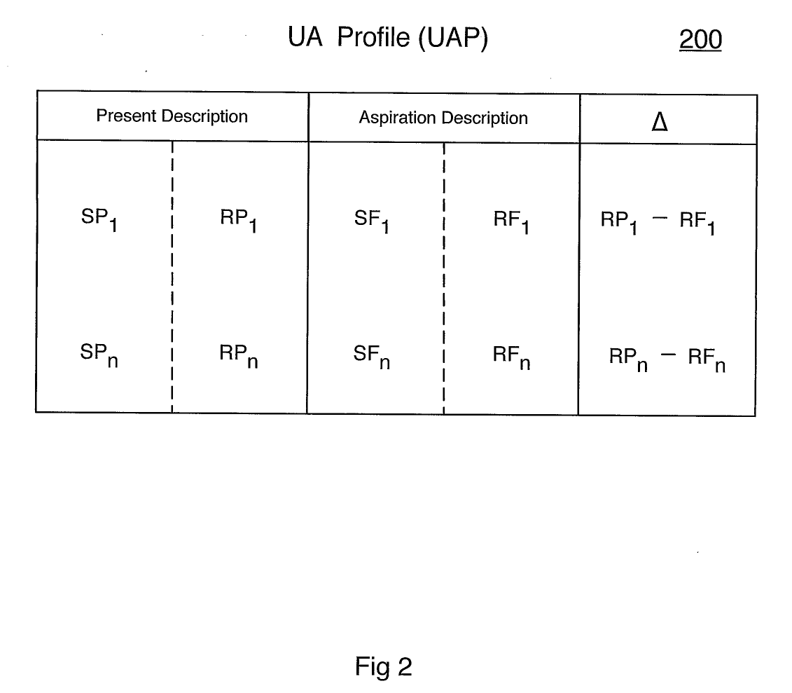

The client/server system provides the User prompts to create or adjust his or her own UAP. FIG. 2 depicts an example of creation of User Aspiration Profile 200 according to an embodiment of the invention. A series of stimulus (SP1 through SPn) are provided to User and the responses (RP1 through RPn) are recorded. This first set of stimulus and responses are calculated to elicit from User and to compose a “present state” or Present Description of his or her personal profile. A second set of stimuli are presented (SPn through SFn) and the responses (RF1 through RFn) are recorded. This second set of stimulus and responses are calculated to elicit from User and to compose a “future state” or “Aspiration Description” of his or her personal profile. The corresponding differences between the responses to stimulus are calculated [RP1-RF1 though RPn-RFn]. The result is a personal UAP for that User.

In one embodiment, the UAP is then compared with an index of personality types, or “Archetypes” and identified with at least one primary Archetype. The Archetypes “indexing metric” applied to UAP supports a method of complementary product indexing according to the same (or reconcilable) Archetype schema. Archetypes in one embodiment are given identifiers, such as Visionary, Inventor, Builder, or Explorer. The type index profile or rating that is assigned as a result of the UAP is provided as feedback to User. Alternatively, in one embodiment the User may elect a “shortcut” and select a profile from a template of pre-designed profiles. These may be so-called “celebrity profiles” representing the Aspiration Profile of well-known sports or entertainment figures.

In another embodiment, the stimulus sets may be selected from a variety of aspects or domains. For example, in addition to “general” profile, specific dimensions calculated to elicit responses germane to physical, mental, emotional or social profiles. Moreover, a User may repeatedly record, update, or adjust stored profiles, as well as collect third party input for inclusion in his or her profile. A User may collect profile information as pertains to him or herself from a significant other, spouse or co-worker, or other third party to further refine his or her UAP.

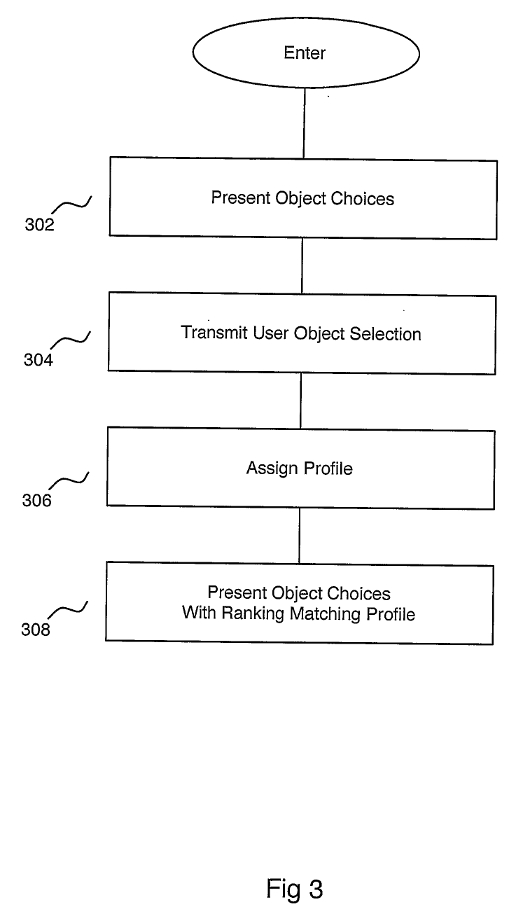

FIG. 3 represents the flow of single action Product-User profile matching according to the present invention. Through a User Interface associated with a client/server communication network, the client presents Object choices 302 to the User. As used herein Object means any representation of an object (e.g. a product, service, or other offering) in a data storage medium in communication with the server. Also, in one embodiment of the invention, the Object has associated with it a pre-determined UAP Rating. With a single User action (e.g., a click of a mouse button), the User selects an Object, and the client transmits the Object selection 304 to the server. The server assigns a UAP, and responds by transmitting Object Choices having UAP Rankings bearing a pre-determined relationship (or “matching”) to the assigned UAP 308. In the case where a User has a UAP from a previous session or from earlier session activity, the server responds with a match to the most recent UAP.

In one embodiment of the invention, the profile/product matching includes the application of an Archetype or personality index correlated to a response or patterns of responses to the stimuli comprising the UAP. Similarly, each Object also may be assigned an “Archetype” either directly, or through the correlation of the Objects profile (also derived from responses to stimuli, also referred to herein as “ranking”, hence UAP Ranking). The “matching” is facilitated by means of the Archetypes of either or both the User and the Object.

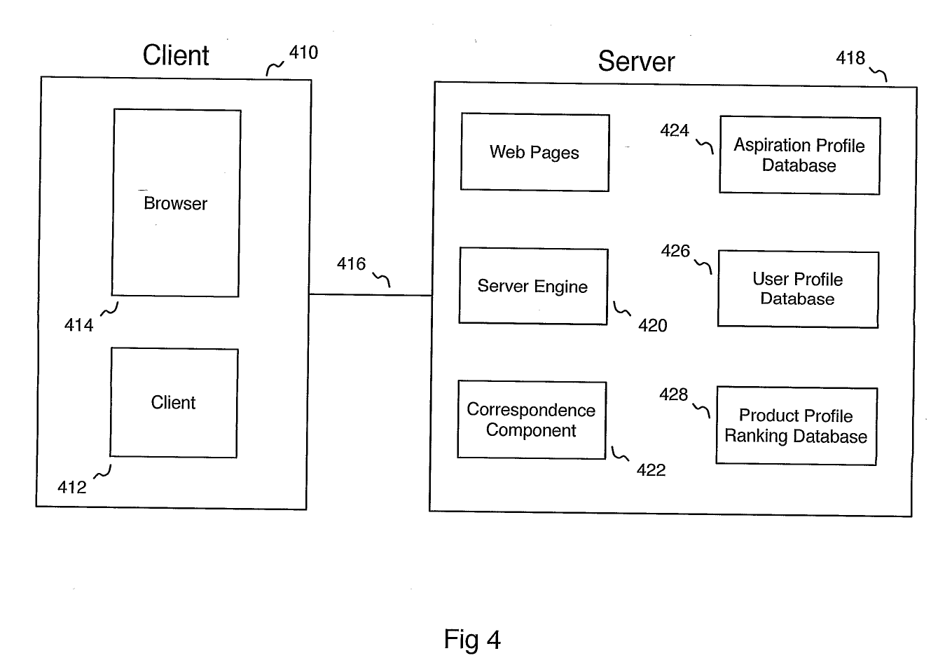

FIG. 4 is a block diagram illustrating an embodiment of the invention. This embodiment supports single action User profile product matching over the Internet using the World Wide Web. The server system 418 includes a server engine 420, various web pages, an Aspiration Profile Database 424, a User Profile Database 426, a Product Profile Ranking Database 428, and a Correspondence Component 422. The server engine receives requests for responses to the transmission of a User Profile. Such a request may be for a specific User Profile; the User Profile Database 426 contains User Profile information. The User Profile transmitted may be a proxy profile (the profile of a selected product); the Product Profile Ranking Database 428 contains profiles of all products in an index complementary to the User Aspiration Profile. The User Profile transmitted may be a personal User Aspiration profile; the Aspiration Profile Database 424 contains User Aspiration Profiles. The Correspondence Component 422 contains algorithms for “matching” a User Aspiration Profile with corresponding Product Profiles. In one embodiment, the Component further contains algorithms for matching Archetypes as may be assigned to UAP or products or both. The client system 410 contains a browser 414 and its assigned Client 412 identifier (e.g., a cookie) that is stored in a file. In one embodiment, the server system assigns and sends the client identifier to the client once when the client system first interacts with the server system, enabling the client to be identified by the server as the source of the messages in all subsequent communications. The server and client interact by exchanging information via a communication link 416 which may include transmission over the Internet.

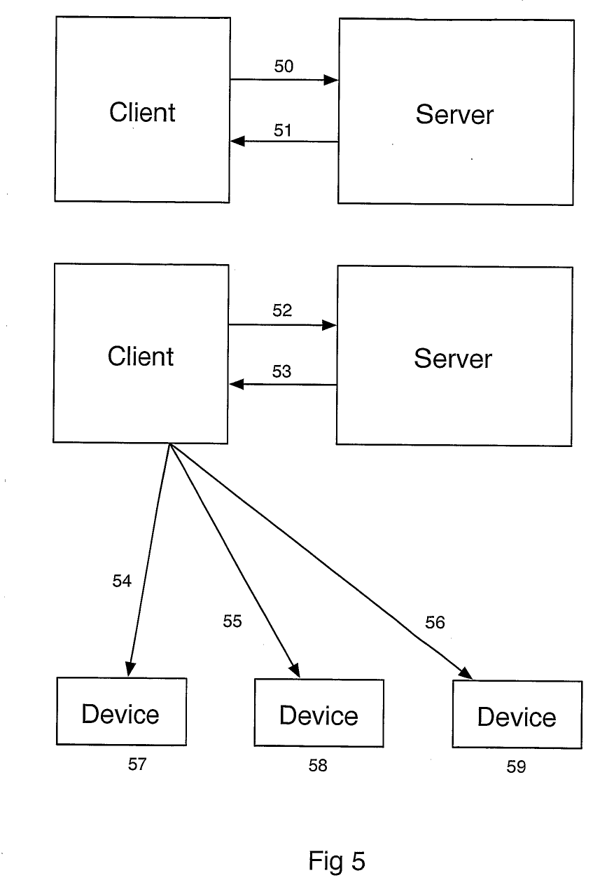

FIG. 5 represents a “push” aspect of the invention in one embodiment. A User may activate a “widget” which causes the server to periodically send product profiles matched to a UAP to any device that can be connected to the communication network. The client sends a “widget request” 50 to the server, which responds by transmitting “widget code” 51 to the client. According to the code properties, the client then “auto-requests” 52 from the server, which responds by sending “widget refreshes” 53 to the client, which then may transmits (54, 55, 56) to any designated device (57, 58, 59). The server dynamically varies presentation of products, and the User may save products of interest to a Wish List, or take other actions. Devices capable of supporting such a widget include but are not limited to smart phones, personal digital assistants (PDAs), laptops, palmtops, camera phones, and other wireless devices. As can be appreciated by those of skill in the art, the widget may present to the User features otherwise available at the User Interface or through the browser associated with the client. These features include but are not limited to UAP creation and “member login.”

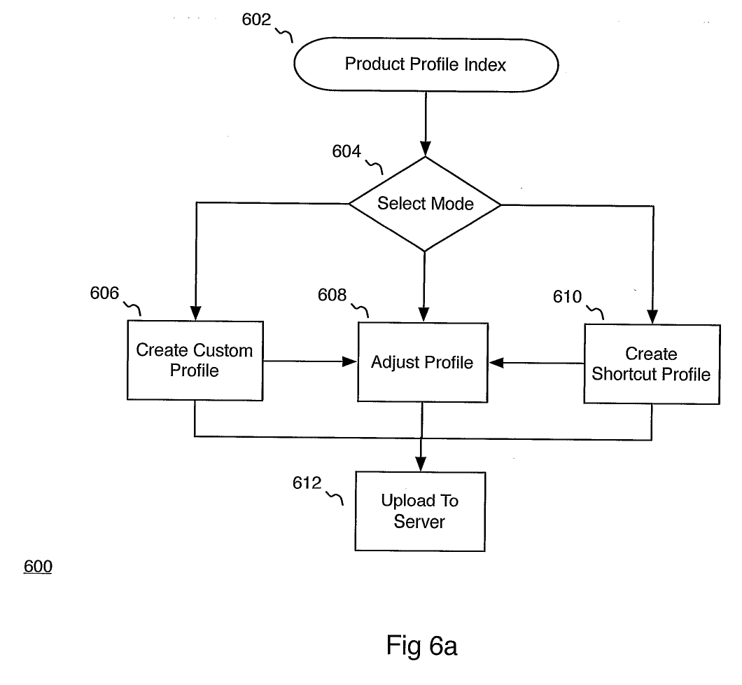

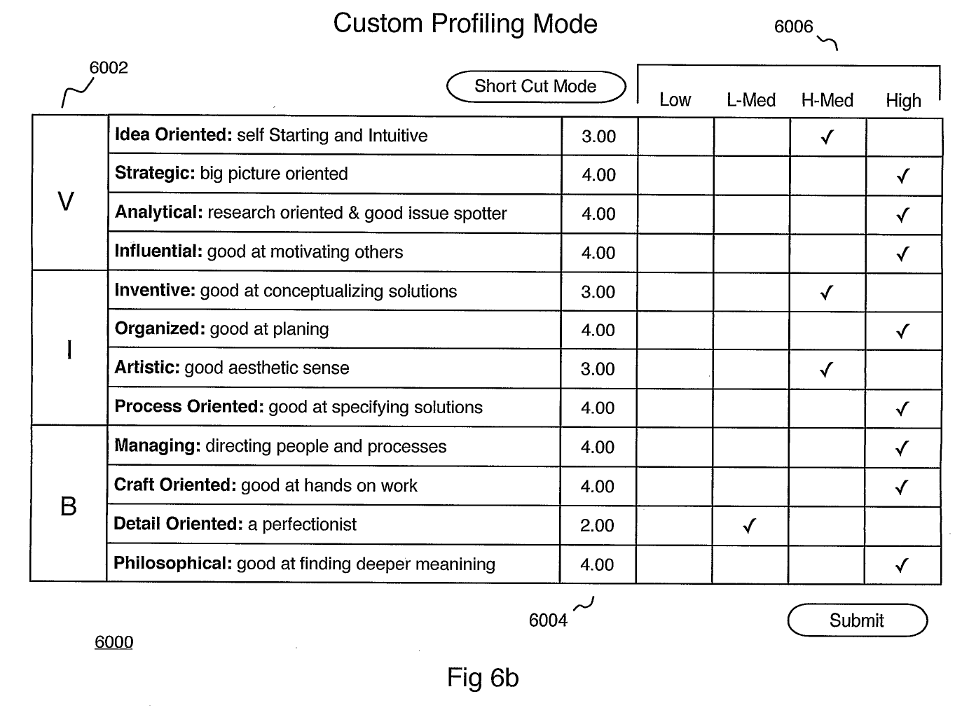

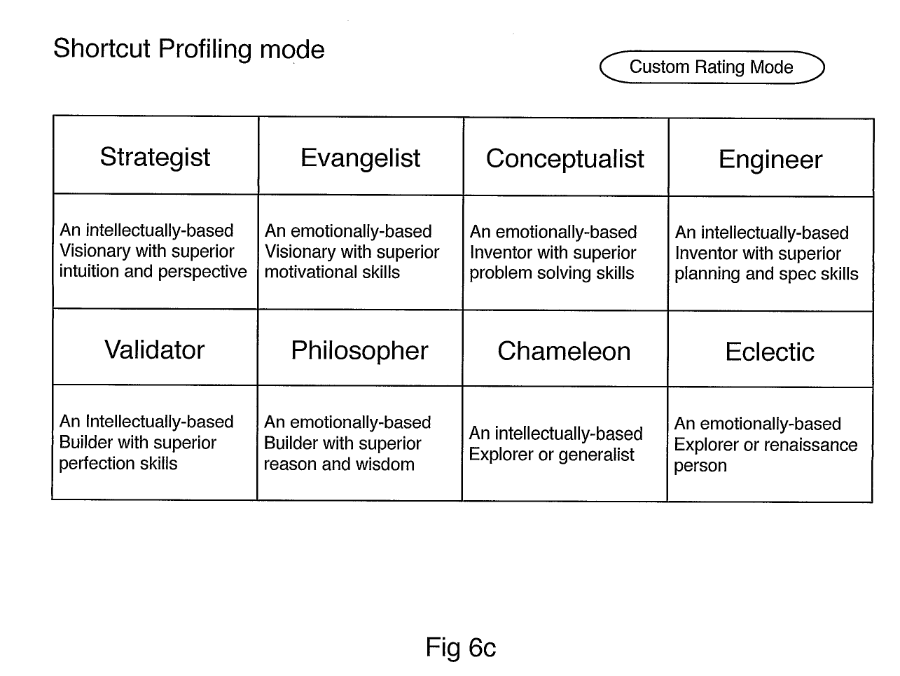

Another aspect of the invention is single action product profile creation, indexing and ranking. Retailers or others enter product data into the Product Profile Ranking Database 428. FIG. 6A is a flow diagram of a routine that processes product profile ranking 600. Through a client (as in FIG. 4) with a browser, a retailer accesses the Product Profile Index 602 and is prompted to Select Mode 604. In one embodiment, either of a Shortcut (single action) profile creation 610 or a Custom profile creation 606 mode may be selected. From either mode, adjustments to product profiles may be entered though Adjust Profile 608, and all entered data uploaded to the server 612.

FIG. 6B is an example of a Custom product profile 6000. In this embodiment, the profiling corresponds to User Aspiration Profile elements 6002, and the retailer ranks (selecting from choices of low, low medium, high medium, and high) 6006 the degree the product conveys or helps improve the specific thought metric indicated. When completed, the submit button saves the data 6004 in the appropriate database.

FIG. 6C is an example of single-action product profile creation, indexing and ranking. The retailer indicates with a single action (e.g., click of a mouse button) the selected pre-designed personality match for a product, and the data is saved in the appropriate database. The invention further provides the option for retailers to create and add single action pre-designed personality profiles (e.g., their own customized personality archetypes).

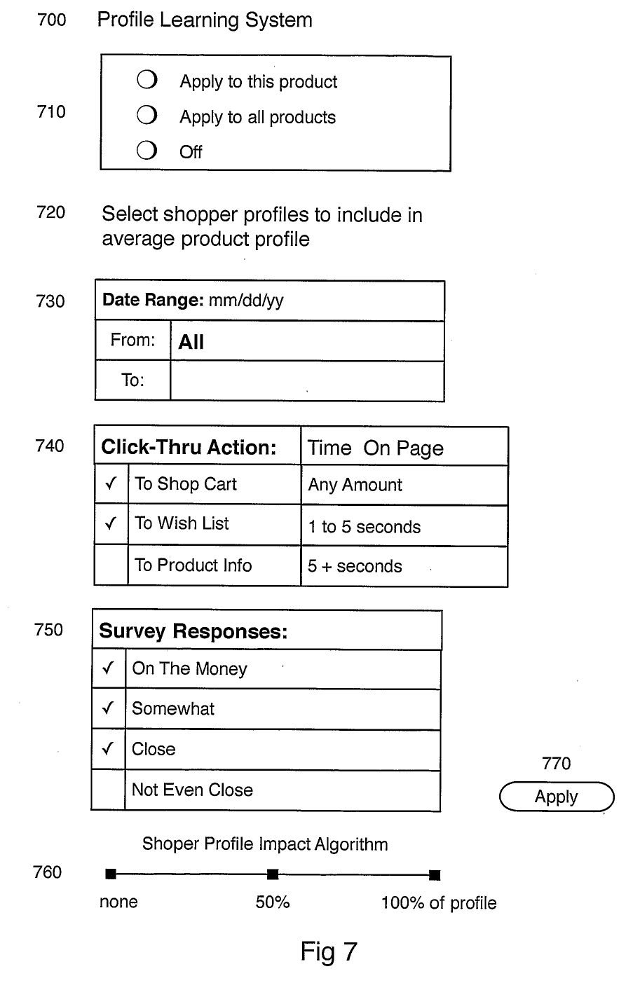

The invention provides a profile learning system whereby User and UAP data collected and stored, may be analyzed. FIG. 7 illustrates profile learning system 700 according to one embodiment of the invention. A sample of settings are presented for selection of some or all products 710, User (shopper) profiles to be included in the average product profile 720, a date range 730, a report of User activity 740, and User survey responses 750, Shopper Profile Impact Algorithm 760, and Apply 770 the settings to the appropriate database or combination of databases in or available to the server. On the basis of such data analysis, any product profile may be adjusted, either manually (FIG. 6, 608) or automatically.

As can be appreciated by one familiar with using databases to generate reports, it is apparent how the inventive system supports the creation of custom reports. User data can be aggregated as it relates to User activity and products, providing valuable trend analysis tools. On the strength of the inventive profiling methodology (i.e., a set of profiling metrics) applicable ubiquitously to any established or newly created product categories, such reports provide data independent of demographic segmentation profiling. Further, the invention provides for automated and dynamic cross selling between related and un-related product categories.

Other applications will be apparent to persons skilled in the art. Although the invention has been described in terms of various embodiments, it is not intended that the invention be limited to these embodiments. Modifications within the scope of the invention will be apparent to those of skill in the art. For example, “stimuli” can be in any form directly or indirectly perceivable by the User: visual, auditory, olfactory, tactile, haptic or any combination. Further, visual stimulus can be language based (e.g., words, sentences, questions) or non-language based (color, shape, symbol, movement). Further, automation of update and input functions, including User and product/Object profile data is considered as within the inventive scope. It is further considered that product profiling input data may include scanning product ids or other high throughput mechanisms. Moreover, the inventive use of “aspirational” user profiles, or UAP, and in particular measurement of user goals, has application in industries such as career planning, travel, entertainment, hobbies, healthcare, wellness, nutrition, fitness, education, mental health, financial planning, real estate and construction, to name a few.

The scope of this invention should therefore not be determined solely by reference to the above description and tables therein, but instead should be determined inclusive of reference to the appended claims and figures, along with the full scope of equivalents to which such claims are entitled.

1. A method for providing data to User via a User Interface comprising the steps of:
a) creating User Aspiration Profile, wherein said User Aspiration Profile is predicated on predictive psychographic data and wherein said User Aspiration Profile is at least partially created as a result of User selection of Object, wherein said Object is presented via said User Interface;
b) providing a response to User session activity with results obtained from at least one database where said database contains Objects, wherein said Objects are associated with complementary Aspiration Profile Ratings, such that the results provided consequent to User session activity bear a pre-determined relation to said User Aspiration Profile.

2. (canceled)

3. A method as in claim 1, wherein the User Aspiration Profile is created by the sub-steps of:
a) collecting User responses to User Profile Creation Stimulus, where such User Profile Creation Stimulus is calculated to evoke expression of self-aspiration;
b) calculating some pre-determined relation between or among responses to stimulus.

4. A method as in claim 3 wherein the predetermined relation is a function of factors, said factors relatable to one or more domains said factors including at least one of the following:
a) averaging of single User responses characterizing present state and future state;
b) averaging of multiple User response to User Profile Creation Stimulus;
c) averaging of responses of other than the User to User Profile Creation Stimulus.

5. (canceled)

6. A method as in claim 1 where the response is to User session activity is responsive to User activity whether or not User actively queries.

7. A method as in claim 6 wherein said response includes more than one Object such that Objects share the same relation to the User Aspiration Profile as well as a complementary relationship to each other.

8. (canceled)

9. (canceled)

10. A method as in claim 7 where said response may be automatically provided to User at any time during or after User session and where providing response to User includes transmission of response to any device connectable to communication network and associated with User.

11. (canceled)

12. A method as in claim 1 wherein the step of providing a response further includes the steps of: employing, with respect to Objects assigned a complementary User Aspiration Profile Rating, a standardized metric derived from User Aspiration Profile so as to rank degree of pre-determined relation to User Aspiration Profile.

13. A method as in claim 12 further including the step of collecting User data during any User interaction with Objects whether during a session or consequent to response on a designated device.

14. (canceled)

15. A method as in claim 13 further including the step of aggregating User data from a plurality of Users, using said aggregate User data to inform one or more Object User Aspiration Profile Ratings, such that Object Aspiration Profile Ratings are adjusted to correlate more closely with User data.

16. A server system for generating pre-indexed objects of pre-determined relevance to User comprising:
a User profiling component where said profiling component is predictive psychometric profiling;
an Object User Profile Ranking component, including:
a data storage medium storing information on a plurality of Users and a plurality of Objects;
a receiving component for receiving requests, a request including an indication of User profile from among a plurality of User profiles, the request being sent in response to any User session activity;
a correspondence component, wherein said correspondence component determines the correspondence of User profile and Object Profile Ranking such that Objects presented to User bear a pre-determined relevance with respect to User Profile.

17. A server system as in claim 16 wherein a request is sent by a client system in response to performance of a single action.

18. A server system as in claim 17 wherein Object Profile Rankings are dynamically refreshed based on aggregate User data.

19. A server system as in claim 18 wherein stored data, including data indicating User data concerning the correspondence of User Profile and Object Profile Rankings, may be analyzed and results of data analysis communicated.

20. A method for matching pre-indexed products to a User using a client system, the method comprising:
providing information regarding one or more products and providing an indication of a single action that is to be performed to request additional information regarding a product;
sending to the server system, in response to performance of a single action, a User Profile associated with a corresponding User Profile Product Ranking, where said User Profile is a predictive psychometric profile;
whereby additional product data determined to bear some pre-determined correspondence with User profile is provided.

21. The method as in claim 18 wherein the client system and server system communicate via the Internet.

22. The method as in claim 20 wherein said providing information includes presentation in any sensory-mode or combination of modes.

23. The method of claim 18 where the single action includes any of the following:
clicking a mouse-button when cursor is positioned over a pre-defined area of display;
touching the display screen over a pre-defined area of display;
generating a sound;
depressing a key on a key pad;
pointing using a pointing device;
selecting using a selecting device.

24. The method of claim 20 further including transmission of data bearing pre-determined relation to the User profile without additional requests from the User.

25. A method for User profiling comprising:
determining User personality profile, where said User personality profile is predicated on psychometric predictive data;
creating a User personality profile metric such that said metric is applicable to the selection of any Object.

26. A method as in claim 25 wherein the User personality profile is derived according to psychometric predictive data relating to User Aspirations, wherein User Aspirations are predicated on a value basis such as self-improvement, personal identity or brand image.

27. A method as in claim 25 wherein the User personality profile metric quantifies one or more of cognitive, creative and emotional aspects of User personality.

28. (canceled)

29. (canceled)

30. A method as in claim 25 further including a plurality of Objects, wherein said Objects are from at least two categories.

31. A method as in claim 30 further including a plurality of User personality profiles.

32. A method as in claim 31 further including analysis of the collected User personality profiles.

33. A method as in claim 30 further including reports created using any portion of analysis of the User personality profiles.
